(19) United States
(12) Patent Application Publication
(10) Pub. No.: US 2026/0355037 A1
(43) Pub. Date: Nov. 12, 2026

(54) ELASTIC LOCOMOTION VIA INSTRUMENTED APPAREL

(71) Applicants: University of Notre Dame du lac, South Bend, IN (US); Brigham Young University, Provo, UT (US)

(72) Inventors: Edgar Bolivar-Nieto, South Bend, IN (US); Minho Lee, South Bend, IN (US); Larry Howell, Provo, UT (US); Nathan Usevitch, Provo, UT (US)

(21) Appl. No.: 19/672,316

(22) Filed: May 8, 2026

Related U.S. Application Data
(60) Provisional application No. 63/803,306, filed on May 9, 2025.

(51) Int. Cl. A61H 1/02

(52) U.S. Cl. CPC A61H 1/024; A61H 2201/165

(57) ABSTRACT

A passive knee exoskeleton includes a first brace positioned along a first limb segment of a wearer, a second brace positioned along a second limb segment, at least one rolling contact joint coupling the first brace to the second brace, and elastic resistance elements coupled to the braces in parallel with the rolling contact joint. The rolling contact joint has a first body and a second body with curved contact surfaces that roll against each other to provide rotation about multiple centers of rotation. The elastic resistance elements store elastic potential energy during movement of the rolling contact joint in a first rotational direction and release it during movement in a second rotational direction to modulate torque at a knee joint. Contact members between the braces have curved outer surfaces contacting the elastic resistance elements during rotation, defining a routing path that varies with rotation angle of the rolling contact joint.

### CROSS-REFERENCE TO RELATED APPLICATIONS

This application claims the benefit of U.S. Provisional Application No. 63/803,306, filed May 9, 2025, the entire disclosure of which is incorporated herein by reference.

### GOVERNMENT LICENSE RIGHTS

This invention was made with government support under grants 2344765 and 2344766 awarded by the National Science Foundation (NSF). The government has certain rights in the invention.

### TECHNICAL FIELD

The present disclosure relates generally to wearable assistive devices, and more specifically to passive joint exoskeletons that use elastic resistance elements and rolling contact joints to augment joint torque during activities.

### BACKGROUND

Sit-to-stand transitions are a fundamental activity of daily living. Adults stand up an average of 60 times per day. For a typical individual, the peak knee torque during sit-to-stand is approximately 34% higher than during level walking, reflecting the demand placed on the knee to lift the whole-body center of mass against gravity. Populations with reduced knee strength, including older adults and individuals recovering from surgery, may have difficulty performing sit-to-stand transitions independently.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a component diagram illustrating an overall architecture of a passive knee exoskeleton integrated into an article of apparel, according to some embodiments.

FIG. 2 is an assembly view illustrating sagittal and frontal views of a passive knee exoskeleton, according to some embodiments.

FIG. 3 is a geometric diagram illustrating a detailed geometry of a rolling contact joint and routing of elastic resistance elements around contact members, according to some embodiments.

FIG. 4 is a graph illustrating force-strain profiles for elastic resistance elements of different stiffness values, according to some embodiments.

FIG. 5 is a photograph illustrating a passive knee exoskeleton worn by a wearer during a sit-to-stand transition, according to some embodiments.

FIG. 6 is a graph illustrating an elliptical region of stiffness and preload combinations that reduce RMS knee torque for a given user, according to some embodiments.

FIG. 7 is a flowchart illustrating a method of making a passive knee exoskeleton, according to some embodiments.

### DETAILED DESCRIPTION

The present disclosure describes a passive exoskeleton for a joint of a wearer. Although the following description focuses on a knee exoskeleton as an illustrative embodiment, the disclosed architecture is applicable to other joints having multiple centers of rotation, such as an elbow, an ankle, or a joint of a humanoid robot. References to the knee joint throughout this description are provided by way of example and are not intended to limit the scope of the present disclosure.

One approach to reduce joint torque during activities such as sit-to-stand transitions is to use an exoskeleton. A joint exoskeleton is a wearable device that produces torque in the joints to assist during activities such as walking, ascending stairs, descending stairs, and sit-to-stand. There are two types of joint exoskeletons: active and passive. Active exoskeletons provide torque assistance through an external power source (e.g., electromagnetic, hydraulic, or pneumatic actuators). Although external power sources can inject positive net joint power, it is a challenge to control this power to assist the user in arbitrary conditions or reduce the mass associated with extra batteries and embedded electronics. Passive exoskeletons use passive components (e.g., dampers, springs, or clutches) that store and release elastic potential energy without batteries or embedded electronics, which enables lighter and simpler designs. A person can store elastic potential energy in a spring while sitting and release it during the sit-to-stand transition to reduce knee torques.

The stiffness and preload of a parallel spring are factors in reducing the root-mean-square (RMS) torque produced by muscle action. To find the optimal stiffness and preload, existing methods (e.g., passive dynamics or trial and error) are practical and simple, but they are difficult to find the optimal values of variables. However, numerical optimization can find the globally or locally optimal values. The optimal values depend on the user's height, weight, and the activity being performed.

Some implementations of passive knee exoskeletons uses revolute joints to represent knee joints and coil springs to provide additional torque during activities. A revolute joint has one center of rotation, unlike a human knee joint that has multiple centers of rotation. Beyond the difference in the number of centers of rotation, the problem is a kinematic mismatch between the exoskeleton and the human that causes the relative motion between those bodies, leading to user discomfort. To represent joints with multiple centers of rotation, rolling contact joints have been designed and applied to passive knee exoskeletons. However, few mechanical models describe a method to mechanically implement a parallel spring in a modular passive knee exoskeleton with rolling contact joints that use a compliant mechanism.

The present disclosure addresses these limitations by providing a passive exoskeleton, referred to herein as Elastic Locomotion Via Instrumented Apparel (ELVIA), that mechanically implements a parallel spring in a modular passive exoskeleton using compliant rolling contact joints and elastic resistance elements (e.g., elastic resistance tubes such as TheraBand resistance tubes). The exoskeleton contains a first brace (e.g., an upper brace) configured to be positioned along a first limb segment (e.g., the thigh) and a second brace (e.g., a lower brace) configured to be positioned along a second limb segment (e.g., the shank) to provide structural integrity. Rolling contact joints couple the first brace to the second brace and rotate with multiple centers of rotation. A series of elastic resistance elements are coupled to the first brace and the second brace and arranged in parallel with the rolling contact joints. The elastic resistance elements are configured to store elastic potential energy during movement of the rolling contact joints in a first rotational direction and to release the elastic potential energy during movement in a second rotational direction to modulate torque at a knee joint. In a first configuration, the elastic resistance elements store elastic potential energy during flexion and release it during extension, e.g., to reduce torque during activities such as sit-to-stand transitions. In a second configuration, the elastic resistance elements store elastic potential energy during extension and release it during flexion, e.g., to provide resistance loading for strength training.

In some embodiments, the elastic resistance elements are routed through apertures in the first and second braces. The elastic resistance elements may be sewn through holes on the first and second braces so that they allow for changing preload of the exoskeleton if needed. In other embodiments, the elastic resistance elements may be coupled to the braces by clips, hooks, friction-fit channels, or other fastening methods. Contact members (e.g., kneecap guards) positioned between the braces have curved outer surfaces that contact the elastic resistance elements during rotation of the rolling contact joints. The contact members define a routing path for the elastic resistance elements that varies as a function of the rotation angle of the rolling contact joints, producing a torque-angle profile that can be tailored to provide assistance where it is most needed during a given activity.

In some embodiments, the exoskeleton is modular so that it can generate different torque profiles, which minimize the RMS knee torque for each user with different heights and weights during sit-to-stand transitions by changing elastic resistance element stiffness (e.g., selecting among elastic resistance tubes of different colors, where each color corresponds to a different stiffness) and contact member size. This modularity enables the torque profile to be customized for different users without requiring structural redesign or electronic control. The stiffness and preload of the exoskeleton may be selected using an optimization framework that identifies the values minimizing RMS joint torque for a given user and activity.

In some embodiments, a characteristic component of the exoskeleton is the compliant rolling contact joint. The actual human knee joint rotates with multiple centers of rotation because the femur and tibia bones roll against each other on the contact surface. The rolling contact joint is designed to have multiple centers of rotation, like the human knee joint, by using the mechanism of Jacob's ladder. Jacob's ladder has multiple rigid bodies connected to each other by flexible elements and rotates without ball bearings. The rolling contact joint has two rigid bodies (a first body and a second body) with curved contact surfaces. These rigid bodies are connected through flexures (e.g., stripes of polycarbonate) as flexible components. The curved contact surfaces of the first and second bodies can be designed based on the geometry of the lateral knee joint from anatomical literature, with the first body having a radius corresponding to the femur geometry and the second body having a radius corresponding to the tibia geometry. Using a compliant mechanism allows the rolling contact joint to be 3D-printed (or otherwise additively manufactured) as a single monolithic part, saving time from part assembly. The rolling contact joint rotates with less friction between rigid bodies, unlike gears. Moreover, the rolling contact joint does not easily buckle because the flexures hold rigid bodies to prevent misalignment during rotation.

In some embodiments, the exoskeleton is integrated into an article of apparel. The first brace and the second brace are attached to the article of apparel by sewing rigid components (e.g., carbon fiber rods) in the medial and lateral sides of the article of apparel (e.g., pants, shorts, leggings, or a full-body suit). As a result, the exoskeleton load is distributed over the complete area of the first limb segment and the second limb segment. The user experience is comfortable, as the load is well distributed within the limb, as opposed to traditional Velcro or localized regions that spread the load in a small area. The exoskeleton can be worn during regular daily activities without impeding natural motion.

The disclosed passive exoskeleton offers several technical advantages. The rolling contact joints provide rotation about multiple centers of rotation, reducing kinematic mismatch with the human knee and improving user comfort compared to revolute-joint designs. The elastic resistance elements provide passive torque assistance without batteries or electronics, resulting in a lightweight device. The modular design allows the torque profile to be customized per user by selecting elastic resistance elements of appropriate stiffness and contact members of appropriate size, without electronic control or structural modification. The apparel-integrated construction distributes loads over the full limb surface area, improving comfort and enabling use during daily activities. The monolithic rolling contact joints reduce part count and assembly time. Additionally, the exoskeleton can serve as a resistance training device during regular motion in environments where gravity is reduced or absent, such as during spaceflight. The exoskeleton allows strength training while performing regular motion within a mission, alleviating the time burden associated with dedicated periods of exercise. The exoskeleton provides resistance loading to the lower extremity muscles during ordinary locomotion without requiring dedicated exercise equipment.

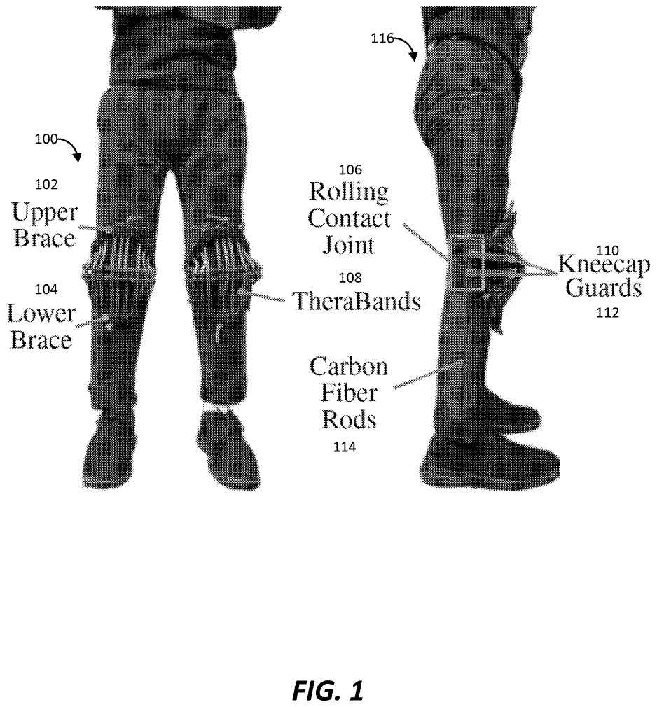

Referring now to FIG. 1, a passive knee exoskeleton 100, referred to herein as Elastic Locomotion Via Instrumented Apparel (ELVIA), is shown integrated into an article of apparel 116 on a wearer, according to some embodiments. FIG. 1 includes a frontal view (left) of the exoskeleton 100 as worn and a lateral view (right) with the fabric of the article of apparel 116 partially removed to show internal components.

The passive knee exoskeleton 100 includes a first brace 102 (e.g., an upper brace) configured to be positioned along a first limb segment of the wearer (e.g., the thigh) and a second brace 104 (e.g., a lower brace) configured to be positioned along a second limb segment of the wearer (e.g., the shank). The first brace 102 and the second brace 104 provide structural integrity for the exoskeleton 100. In some embodiments, the first brace 102 and/or the second brace 104 are rigid or semi-rigid structures extending along medial and lateral sides of the wearer. In some embodiments, the first brace 102 and/or the second brace 104 may include other materials such as thermoplastics, fiber-reinforced composites, or metals.

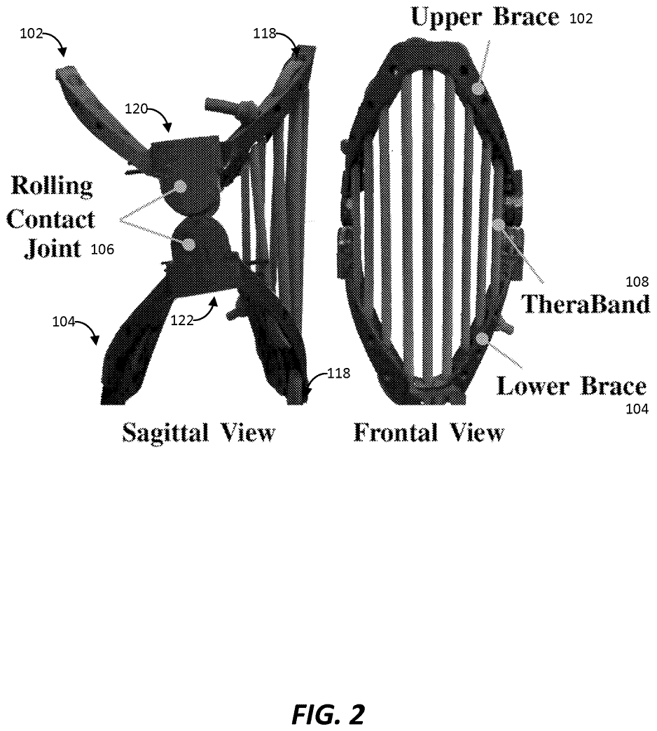

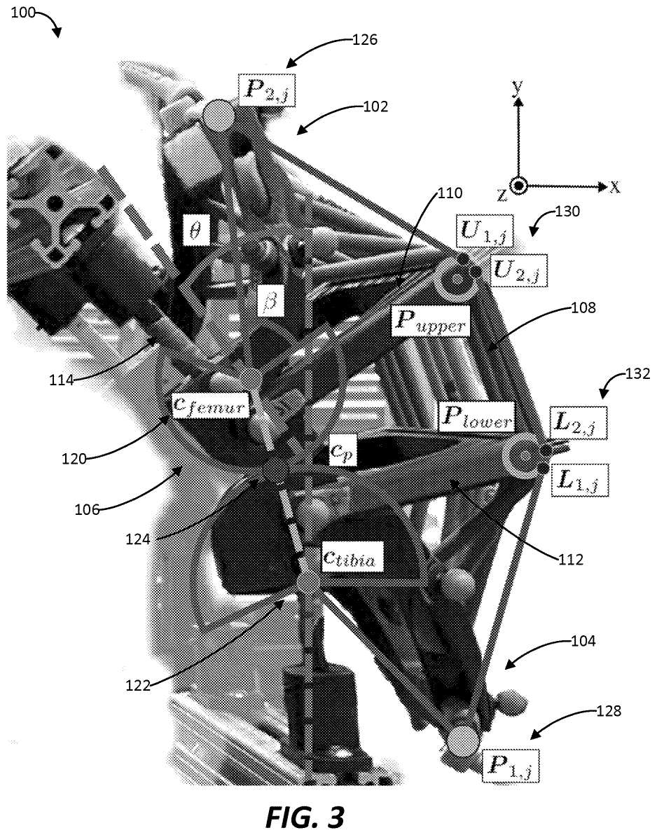

Two rolling contact joints 106 couple the first brace 102 to the second brace 104 and rotate with multiple centers of rotation. The rolling contact joints 106 are positioned on opposing lateral and medial sides of the knee joint of the wearer. Each rolling contact joint 106 includes a first body and a second body having respective curved contact surfaces that roll against each other to provide rotation about multiple centers of rotation. In some embodiments, a single rolling contact joint 106 may be used. The rolling contact joints 106 are described in further detail below with reference to FIGS. 2 and 3.

One or more elastic resistance elements 108 (e.g., a series of TheraBand resistance tubes) are coupled to the first brace 102 and the second brace 104 to store elastic potential energy. The elastic resistance elements 108 are arranged in parallel with the rolling contact joints 106. A person can store elastic potential energy in the elastic resistance elements 108 while sitting and release it during the sit-to-stand transition to reduce knee torques. In the embodiment shown in FIG. 1, nine elastic resistance elements 108 are arranged in parallel between the first brace 102 and the second brace 104. In other embodiments, a different number of elastic resistance elements 108 may be used. In some embodiments, the elastic resistance elements 108 comprise elastic resistance tubes, such as TheraBand resistance tubes. In other embodiments, the elastic resistance elements 108 may include elastic bands, elastic cords, rubber tubing, bungee cords, or other elastic materials capable of storing and releasing elastic potential energy.

The elastic resistance elements 108 are sewn or routed through holes (apertures) on the first brace 102 and the second brace 104 so that they allow for changing preload of the exoskeleton 100 if needed. In other embodiments, the elastic resistance elements 108 may be coupled to the first brace 102 and the second brace 104 by clips, hooks, friction-fit channels, or other fastening techniques.

An upper contact member 110 (e.g., an upper kneecap guard) may be coupled to the first brace 102, and a lower contact member 112 (e.g., a lower kneecap guard) may be coupled to the second brace 104. The upper contact member 110 and the lower contact member 112 are positioned between the first brace 102 and the second brace 104. The upper contact member 110 and/or the lower contact member 112 may have a curved outer surface that contacts at least a portion of the plurality of elastic resistance elements 108 during rotation of the rolling contact joints 106. The contact between the contact members 110, 112 and the elastic resistance elements 108 may define a routing path for the elastic resistance elements 108 that varies as a function of a rotation angle of the rolling contact joints 106. The geometry of the contact members 110, 112 and their effect on the routing path are described in further detail below with reference to FIG. 3.

The exoskeleton 100 is modular so that it can generate different torque profiles, which minimize the RMS knee torque for each user with different heights and weights during sit-to-stand transitions by changing elastic resistance element stiffness and contact member size. For example, the elastic resistance elements 108 are individually replaceable with elastic resistance elements of different stiffness (e.g., TheraBand resistance tubes are available in multiple colors such as red, green, blue, black, and silver, where each color corresponds to a different stiffness value). The upper contact member 110 and the lower contact member 112 are interchangeable with contact members of different sizes (e.g., 90 mm and 100 mm lengths). Small modifications to the design of the exoskeleton 100 can make the device useful for other human joints.

In some embodiments, the passive knee exoskeleton 100 is integrated into the article of apparel 116. The first brace 102 and the second brace 104 are attached to the article of apparel 116 by sewing rigid structural elements 114 (e.g., carbon fiber rods) in the medial and/or lateral sides of the article of apparel 116 (e.g., pants). The article of apparel 116 may also be, for example, shorts, leggings, a full-body suit, or another garment. As a result, the exoskeleton load is distributed over the complete area of the first limb segment (e.g., the thigh) and the second limb segment (e.g., the shank) of the wearer. The user experience is comfortable, as the load is well distributed within the limb, as opposed to traditional Velcro straps or localized regions that spread the load in a small area. In other embodiments, the first brace 102 and the second brace 104 may be attached to the article of apparel 116 by adhesive bonding, hook-and-loop fasteners, snap fasteners, or other attachment methods. The exoskeleton 100 can be worn during regular daily activities without impeding natural motion.

Referring now to FIG. 2, the passive knee exoskeleton 100 is shown removed from the article of apparel 116, according to some embodiments. FIG. 2 includes a sagittal view (left) and a frontal view (right) of the exoskeleton 100.

The sagittal view shows the rolling contact joint 106 coupling the first brace 102 to the second brace 104. The actual knee joint rotates with multiple centers of rotation because the femur and tibia bones roll against each other on the contact surface. The rolling contact joint 106 is designed to have multiple centers of rotation, like the human knee joint, by using the mechanism of Jacob's ladder. Jacob's ladder has multiple rigid bodies connected to each other by flexible elements and rotates without ball bearings.

The rolling contact joint 106 includes a first body 120 and a second body 122 having respective curved contact surfaces. The first body 120 and the second body 122 are connected through a plurality of flexures (e.g., three stripes of polycarbonate film) as flexible components. In some embodiments, the first body 120 and the second body 122 and the plurality of flexures are formed as a monolithic structure. Using a compliant mechanism allows the rolling contact joint 106 to be 3D-printed (or otherwise additively manufactured) as a single part. 3D printing in one part saves time from part assembly. In other embodiments, the rolling contact joint 106 may be formed by injection molding, CNC machining, or other fabrication methods that produce the first body 120, the second body 122, and the plurality of flexures as a single monolithic part or as assembled components.

In some embodiments, the plurality of flexures include polycarbonate film. In some embodiments, the plurality of flexures include a polymer composite such as a chopped carbon fiber and nylon composite (e.g., Onyx manufactured by Markforged), which may be formed by additive manufacturing. In some embodiments, the plurality of flexures may comprise other flexible materials such as spring steel, polyethylene terephthalate (PET), nylon, or other polymer films capable of repeated bending. In the embodiment shown in FIG. 2, three flexures connect the first body 120 to the second body 122. In other embodiments, a different number of flexures may be used.

The rolling contact joint 106 rotates with less friction between the first body 120 and the second body 122, unlike gears. Moreover, the rolling contact joint 106 does not easily buckle because the flexures hold the first body 120 and the second body 122 to prevent misalignment during rotation.

In some embodiments, the curved contact surfaces of the first body 120 and the second body 122 are circular. The radius of the curved contact surface of the first body 120 may differ from the radius of the curved contact surface of the second body 122. The femur and tibia circles may be configured based on the geometry of the lateral knee joint from anatomical literature, with the first body 120 having a radius corresponding to the femur geometry and the second body 122 having a radius corresponding to the tibia geometry. In other embodiments, the curved contact surfaces may have other curved geometries, such as elliptical, cam-shaped, or anatomically contoured profiles, depending on the joint being assisted.

The frontal view of FIG. 2 shows the plurality of elastic resistance elements 108 routed through apertures 118 in the first brace 102 and the second brace 104. The first brace 102 defines a first plurality of apertures 118, and the second brace 104 defines a second plurality of apertures 118. Each elastic resistance element 108 is routed through at least one aperture 118 of the first plurality of apertures and at least one aperture 118 of the second plurality of apertures. In the embodiment shown in FIG. 2, nine elastic resistance elements 108 are visible in the frontal view, routed in parallel between the first brace 102 and the second brace 104. Two rolling contact joints 106 are visible on opposing lateral and medial sides of the exoskeleton 100.

Referring now to FIG. 3, a geometric diagram of the rolling contact joint 106 and the routing of the elastic resistance elements 108 around the upper contact member 110 and the lower contact member 112 is shown at a rotation angle θ, according to some embodiments. FIG. 3 is a close-up sagittal view of the rolling contact joint region with a geometric overlay showing the positions and relationships of the components during rotation.

A numerical model may be used to estimate the torque of the exoskeleton 100 across a given range of rotation angles. The model may have two rigid bodies representing the first brace 102 (upper brace) and the second brace 104 (lower brace) in the sagittal view. To consider the contact between the contact members 110, 112 (e.g., kneecap guards) and the elastic resistance elements 108 (e.g., TheraBands) of the exoskeleton 100, circles are placed to represent the cross-section of the contact members 110, 112 with a radius rₖₙₑₑ. In some embodiments, the radius rₖₙₑₑ is 38.68 mm. In other embodiments, the radius rₖₙₑₑ may vary depending on the size of the contact members 110, 112 selected for the wearer.

The rolling contact joint 106 is represented by a first body 120 (e.g., a femur circle) having a center c_{femur} and a radius r_{femur} and a second body 122 (e.g., a tibia circle) having a center c_{tibia} and a radius r_{tibia}. A contact point 124 (cₚ) is the position of contact between the first body 120 and the second body 122. The numerical model may use a pure rolling (nonslip) constraint, so that the rolling angle between the first body 120 and the second body 122 (φ) is:

$$φ = \frac{{r}_{femur}}{{r}_{tibia}} \times θ$$

The femur and tibia circles are not aligned vertically in the global coordinate, so the angle of the vector between c_{femur} and c_{tibia} with respect to the global coordinate (α) is:

$$α = arctan ( \frac{{y}_{femur , i} - {y}_{tibia}}{{x}_{femur , i} - {x}_{tibia}} )$$

where x_{femur,i}, y_{femur,i}, x_{tibia}, and y_{tibia} are x and y components of c_{femur,i} and c_{tibia}. The angle between the first brace 102 link and the first body 120 (β) at θ=0 is:

$$β = arctan ( \frac{{y}_{p 2 , i} - {y}_{femur , i}}{{x}_{p 2 , i} - {x}_{femur , i}} )$$

The angle between the upper contact member 110 and the first body 120 (γ) is:

$$γ = 2 π + arctan ( \frac{{y}_{upper , i} - {y}_{femur , i}}{{x}_{upper , i} - {x}_{femur , i}} )$$

Using the gathered geometric information, the numerical model processes calculations at θ configurations to get the estimated torque from the exoskeleton 100. At a rotation angle θ, the positions of c_{femur} and cₚ are:

c_{femur}=c_{tibia}+dᵣ(sin(α+φ),cos(α+φ))

cₚ=c_{tibia}+r_{tibia}(sin(α+φ),cos(α+φ))

where dᵣ is the sum of the radii of the first body 120 and the second body 122:

dᵣ=r_{femur}+r_{tibia}

The upper connection point 126 (P_{2,j}), which is the position of the upper j-th elastic resistance element connection on the first brace 102, and the position of the upper contact member 110 (Pᵤₚₚₑᵣ) at rotation angle θ are:

P_{2,j}=c_{femur}+d_{knee,up}(cos(θ+β), sin(θ+β))

Pᵤₚₚₑᵣ=c_{femur}+d_{knee,up}(cos(θ+γ), sin(θ+γ))

where d_{knee,up} is the distance between the centers of the first body 120 and the upper contact member 110 circle:

d_{knee,up}=∥P_{upper,i}−c_{femur,i}∥₂

The lower connection point 128 (P_{1,j}) is the position of the lower j-th elastic resistance element connection on the second brace 104. The position of the lower contact member 112 (P_{lower}) is fixed on the second brace 104.

To calculate the elongation of the elastic resistance elements 108 (δ_{Thera}), the elastic resistance elements 108 contact the upper contact member 110 and the lower contact member 112 during rotation. Upper tangential contact points 130 (U_{1,j} and U_{2,j}) are the points where the elastic resistance elements 108 contact the curved outer surface of the upper contact member 110. Lower tangential contact points 132 (L_{1,j} and L_{2,j}) are the points where the elastic resistance elements 108 contact the curved outer surface of the lower contact member 112. Each of the upper contact member 110 and the lower contact member 112 has a circular cross-section, and the tangential contact points 130, 132 are the tangent points between the contact member circles and the elastic resistance element lines. In some embodiments, the upper contact member 110 and/or the lower contact member 112 may have a non-circular cross-section, such as an elliptical, oval, or otherwise contoured profile. A slimmer cross-section may be used to reduce the profile of the contact members 110, 112 while maintaining structural integrity, e.g., by using materials of higher specific strength such as machined aluminum or other metals. The tangential contact point calculations described herein may be adapted for non-circular cross-sections by computing the tangent lines to the corresponding non-circular profile geometry.

The upper tangential contact points 130 (U_{1,j}) and lower tangential contact points 132 (L_{1,j}) are:

U_{1,j}=Pᵤₚₚₑᵣ+rₖₙₑₑ(cos(θ_{up,1}), sin(θ_{up,1})

L_{1,j}=P_{lower}+rₖₙₑₑ(cos(θ_{low,1}), sin(θ_{low,1})

where θ_{up,1} and θ_{low,1} are angles of the vector between the upper tangential point and the upper contact member 110 center or the vector between the lower tangential point and the lower contact member 112 center with respect to the global coordinate x-axis.

The other two tangential contact points U_{2,j} and L_{2,j} are:

U_{2,j}=Pᵤₚₚₑᵣ+rₖₙₑₑ×n

L_{2,j}=P_{lower}+rₖₙₑₑ×n

where n is the unit perpendicular vector to the line between the upper contact member 110 and the lower contact member 112 circles.

In some embodiments, only the outermost elastic resistance elements 108 (j=1 and j=9) are elongated between the upper contact member 110 and the lower contact member 112, and the other elastic resistance elements 108 (j=2, . . . , 8) are elongated evenly between the upper connection point 126 (P_{2,j}) and the lower connection point 128 (P_{1,j}). The elongation of the outermost elastic resistance elements 108 (j=1 and 9) is:

δ_{Thera,j}=∥Pᵤₚₚₑᵣ−P_{lower}∥₂−l_{relaxed,j}

The elongation of the other elastic resistance elements 108 is:

β_{Thera,j}=∥P_{2,j}−U_{1,j}∥₂+∥Pᵤₚₚₑᵣ−P_{lower}∥₂+∥L_{1,j}−P_{1,j}∥₂+rₖₙₑₑ·θ_{arc,up}+rₖₙₑₑ·θ_{arc,low}−l_{relaxed,j}

where l_{relaxed,j} is the relaxed length of the j-th elastic resistance element, measured to estimate the preload of the exoskeleton 100, and θ_{arc,up} and θ_{arc,low} are the arc angles subtended by the elastic resistance element on the upper contact member 110 and the lower contact member 112, respectively.

The strain (ε_{Thera,j}) of each elastic resistance element 108 is:

$${ε}_{Thera , j} = \frac{{δ}_{Thera , j}}{{l}_{relaxed , j}}$$

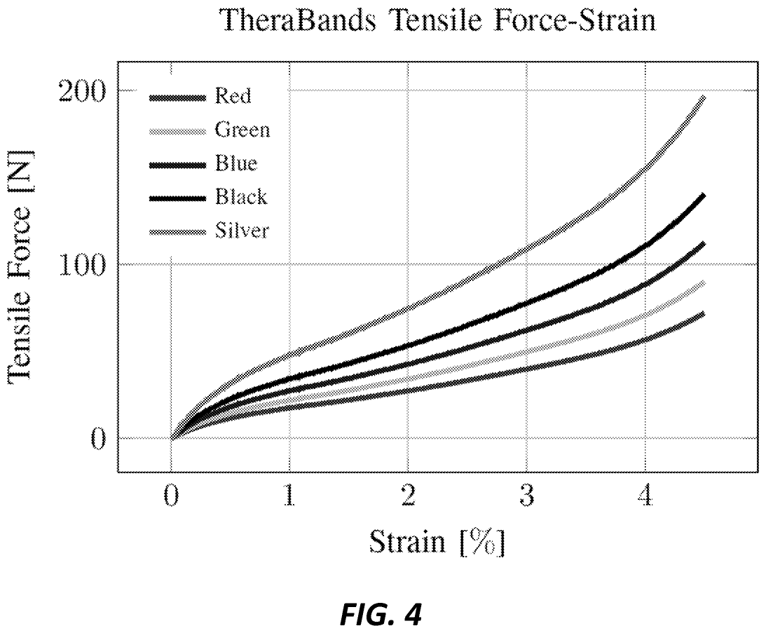

The magnitude of the tensile force F_{Thera,j} of each elastic resistance element 108 is the force value corresponding to ε_{Thera,j} from the elastic resistance element force-strain profile (described with reference to FIG. 4). The torque of each elastic resistance element 108 with respect to the contact point 124 (cₚ) is:

τ_{Thera,j}=(U_{2,j}−cₚ)×F_{Thera,j},for j=1,9

τ_{Thera,j}=(P_{2,j}−cₚ)×F_{Thera,j},otherwise

After each elastic resistance element torque calculation, the total torque of the exoskeleton 100 is calculated by adding all τ_{Thera,j} because the elastic resistance elements 108 are located in parallel with each other:

$${τ}_{elvia} = {\sum }_{j = 1}^{9} {τ}_{Thera , j}$$

The routing path defined by the upper contact member 110 and the lower contact member 112 causes the elongation, and therefore the force and torque contribution, of each elastic resistance element 108 to vary as a function of the rotation angle θ. This produces a nonlinear torque-angle profile from the elastic resistance elements 108 across the range of rotation angles of the rolling contact joint 106, even when the elastic resistance elements 108 individually have a linear or near-linear force-elongation characteristic. The preload of the elastic resistance elements 108 is adjustable by changing the relaxed length l_{relaxed,j}, which can be changed by re-routing the elastic resistance elements 108 through different apertures 118 or by re-threading the elastic resistance elements 108 to change their effective routing length through the first brace 102 or the second brace 104.

Referring now to FIG. 4, force-strain profiles for elastic resistance elements 108 of different stiffness values are shown, according to some embodiments. FIG. 4 plots tensile force (N) on the vertical axis versus strain (%) on the horizontal axis for multiple elastic resistance elements 108, where each curve corresponds to an elastic resistance element 108 of a different stiffness.

In some embodiments, the elastic resistance elements 108 are elastic resistance tubes available in multiple colors, where each color corresponds to a different stiffness value. For example, TheraBand resistance tubes are available in colors such as red, green, blue, black, and silver, listed in order of increasing stiffness. The strain-tensile force profile of each color of elastic resistance tube was characterized using a 68FM-300 universal testing system (Instron, Massachusetts, U.S.). Other colors of elastic resistance tubes can be estimated by multiplying gains from the manufacturer's specifications based on a reference elastic resistance tube force-strain profile (e.g., the red TheraBand force-strain profile).

As shown in FIG. 4, the force-strain curves are nonlinear for each color of elastic resistance element 108, and the curves diverge at higher strains. A stiffer elastic resistance element 108 (e.g., silver) produces a higher tensile force at a given strain compared to a less stiff elastic resistance element 108 (e.g., red). This characteristic enables selection of different elastic resistance elements 108 to produce different torque profiles in the exoskeleton 100.

The magnitude of the tensile force F_{Thera,j} of each elastic resistance element 108 is the force value corresponding to the strain ε_{Thera,j} from the force-strain profile shown in FIG. 4. The strain ε_{Thera,j} is determined by the elongation δ_{Thera,j} and the relaxed length l_{relaxed,j} of the elastic resistance element 108 as described with reference to FIG. 3.

Because the elastic resistance elements 108 are individually replaceable, the stiffness of each elastic resistance element 108 in the exoskeleton 100 can be selected independently. For example, in some embodiments, the middle three elastic resistance elements 108 (j=4, 5, 6) may be a stiffer color (e.g., silver or black) while the other six elastic resistance elements 108 may be a less stiff color (e.g., red). This allows the torque profile of the exoskeleton 100 to be tailored to provide more or less assistance at particular rotation angles. In other embodiments, all elastic resistance elements 108 may be the same color, or other combinations of colors may be used. In still other embodiments, the elastic resistance elements 108 may include materials other than TheraBand resistance tubes, such as elastic bands, elastic cords, or rubber tubing having different stiffness values.

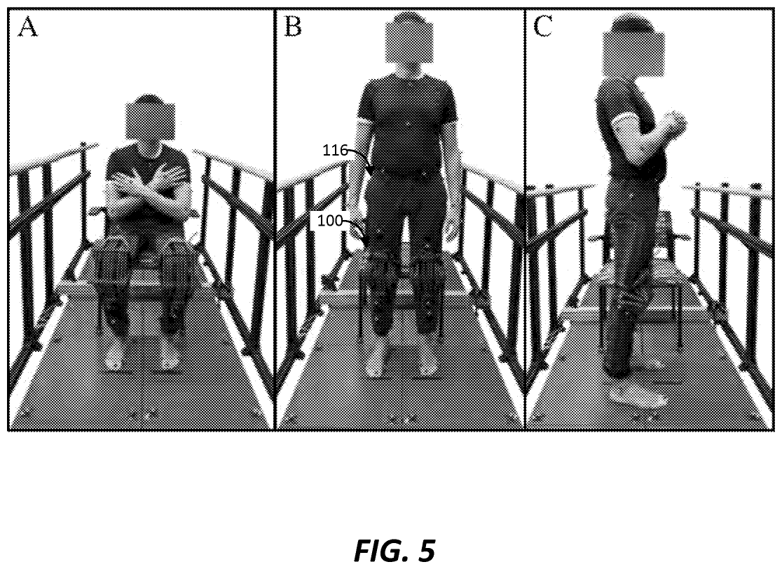

Referring now to FIG. 5, the passive knee exoskeleton 100 is shown worn by a wearer during a sit-to-stand transition, according to some embodiments. FIG. 5 includes three views: (A) a frontal view in the sitting position, (B) a frontal view in the standing position, and (C) a sagittal view in the standing position.

The exoskeleton 100 is integrated into the article of apparel 116 (e.g., pants) and is positioned such that the rolling contact joints 106 are aligned with the wearer's knee joints. The first brace 102 is positioned along the first limb segment (thigh) and the second brace 104 is positioned along the second limb segment (shank). The article of apparel 116 fixes the exoskeleton 100 in one position where its joints are aligned with the wearer's knee joints. In some embodiments, the exoskeleton 100 is attached to the article of apparel 116 by sewing.

In some embodiments, the exoskeleton 100 was tested to evaluate biomechanical benefits during sit-to-stand transitions. The exoskeleton 100 was tested using a motion capture system and force plates to evaluate kinematics and dynamics parameters of a wearer with and without the exoskeleton 100. The placement of reflective markers followed full body skeleton marker sets. A pilot test was performed with a healthy 37-year-old male who weighed 73.8 kg with a height of 1.78 m.

Before a data collection session, the weight and height of the wearer were obtained. Based on the given height and weight of the wearer, the optimal stiffness and preload that minimizes RMS knee torque during the sit-to-stand without hurting other activities (e.g., level walking and stairs gait) can be found by using an optimization tool. With the optimization tool, the numerical model described above with reference to FIG. 3 gives the optimal exoskeleton design parameters to achieve the optimal stiffness and preload by computing the first-order finite difference of the exoskeleton torque-rotation angle simulation. For example, for a wearer weighing 73.8 kg with a height of 1.78 m, the exoskeleton design parameters were: (1) 100 mm upper and lower contact members 110, 112, (2) black elastic resistance elements 108 for j=4, 5, 6, and (3) red elastic resistance elements 108 for the other six positions.

During testing, the wearer performed sit-to-stand transitions at a controlled pace in two conditions: (1) with and (2) without the exoskeleton 100. At the starting position, the wearer was seated on a chair and located their feet where allowed to perform the sit-to-stand naturally while crossing arms, as shown in view (A) of FIG. 5.

The exoskeleton 100 produces an assisting moment of approximately 25.02 Nm in the sitting position. The mean RMS knee torque values were 48.43 Nm in the condition without the exoskeleton 100 and 37.43 Nm in the condition with the exoskeleton 100. Based on a comparison of the mean values, the exoskeleton 100 reduces the mean RMS knee torque by 22.71% compared to the configuration without the exoskeleton 100 (p<0.05). These results demonstrate that the exoskeleton 100 provides biomechanical benefits to users to perform sit-to-stand transitions with lower RMS knee torque.

In some embodiments, the exoskeleton 100 can also be used for strength training in low- or no-gravity environments. Compared to existing stationary exercise devices, the exoskeleton 100 allows strength training while performing regular motion within a mission, alleviating the time burden associated with dedicated periods of exercise. The exoskeleton 100 provides resistance loading to the lower extremity muscles during ordinary locomotion without requiring dedicated exercise equipment.

The plurality of elastic resistance elements 108 may be configured to operate in multiple modes. In one mode, the elastic resistance elements 108 store elastic potential energy during flexion of the at least one rolling contact joint 106 and release the stored energy during extension to assist the wearer by reducing torque at the joint during activities such as sit-to-stand transitions, stair ascent, and stair descent. In another mode, the elastic resistance elements 108 store elastic potential energy during extension of the at least one rolling contact joint 106 and release the stored energy during flexion to provide resistance loading to the wearer, e.g., for strength training purposes. The mode of operation may be selected by configuring the routing of the elastic resistance elements 108 through the apertures 118 of the first brace 102 and the second brace 104, or by selecting appropriate stiffness values and preload settings for the elastic resistance elements 108. These modes of operation use the same mechanical architecture of the exoskeleton 100 without requiring structural modification.

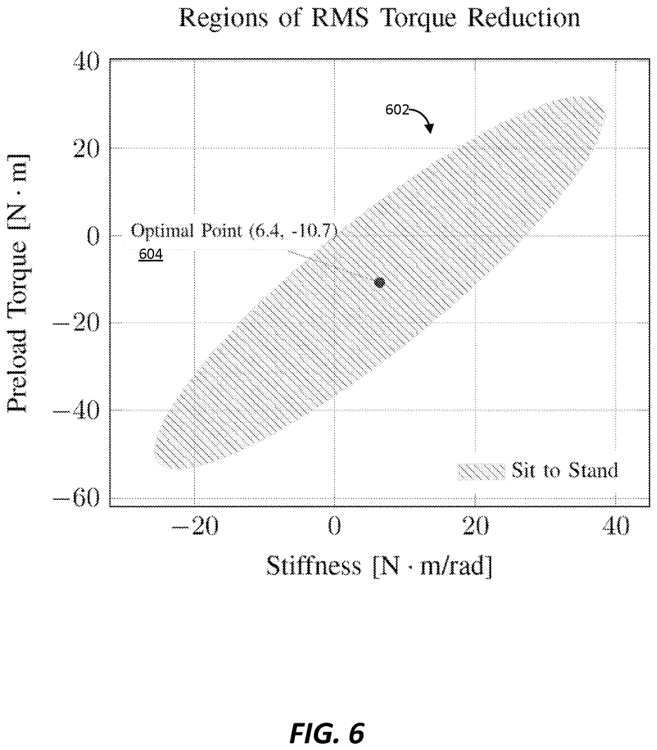

Referring now to FIG. 6, an elliptical region 602 of stiffness and preload combinations that reduce RMS knee torque for a given user is shown, according to some embodiments. FIG. 6 plots preload torque (N·m) on the vertical axis versus stiffness (N·m/rad) on the horizontal axis.

The stiffness and preload of a parallel spring are important factors in reducing the RMS torque produced by muscle action. To find the optimal stiffness and preload, the sit-to-stand RMS knee torque of a nonlinear spring in parallel with the knee joint is formulated as a function of spring coefficients. In this convex optimization, the optimization finds the minimum RMS sit-to-stand knee torque with coefficients of spring polynomials as optimization variables and a positive spring stiffness constraint.

Balancing torques at a human knee joint:

τₑ+τₛ+τₗ=0

where τₑ, τₛ, and τₗ are human knee torque, spring torque, and load from a given knee kinematic dataset. The RMS knee torque is:

$$RMS ( τ ) = \sqrt{\frac{1}{{t}_{f} - {t}_{0}} {\int }_{{t}_{0}}^{{t}_{f}} {τ}_{e}^{2} dt}$$

The relationship between elongation and spring torque is:

τₛ(δ,a)=−(aₙδⁿ+aₙ₋₁δⁿ⁻¹+ . . . +a₁δ)+a₀

where δ is the knee rotation angle trajectory, aₙ through a₁ are the coefficients of the n^{th}-degree polynomial spring torque function, and a₀ is the preload. The optimization variable vector is x=[aₙ, . . . , a₁, a₀]^{T}∈ [symbol] ⁿ⁺¹.

By substituting the spring torque into the torque balance, the human knee torque becomes an affine function of the optimization variables. The RMS knee torque can then be expressed as a convex quadratic function:

x^{T}Qx+2q^{T}x+c

where Q is a positive semidefinite matrix. The constraint is the positive spring stiffness, which is the derivative of the spring torque function with respect to δ:

$${\sum }_{i = 1}^{n} i \cdot {a}_{i} \cdot {δ}^{i - 1} \geq 0$$

With the RMS knee torque equation and the positive spring stiffness constraint, the optimal coefficients and preload of a nonlinear parallel spring are the solution to a quadratic convex optimization problem. In some embodiments, simulations are performed using the CLARABEL solver from CVXPY (a Python-embedded modeling language for convex optimization problems) running on a computing device including a memory storing computer-readable instruction that, when executed by a processor of the computing device, cause the computing device to perform the calculations (e.g., simulations, optimizations) described herein (e.g., minimize the convex quadratic function subject to the spring torque function).

As shown in FIG. 6, the elliptical region 602 represents all stiffness-preload combinations that reduce RMS knee torque compared to a no-spring configuration. Any point in the interior of the elliptical region 602 represents a combination of parallel stiffness and preload that reduces RMS torque compared to a no-spring configuration. The center of the elliptical region 602 is the optimal stiffness and preload point 604, which denotes the optimal spring for the sit-to-stand task. For a user of 1.76 m height and 67.8 kg mass, for example, the optimal stiffness and preload are 6.4 N·m/rad and −10.7 N·m, respectively.

The optimization was simulated from the 1^{st} (linear) up to the 7^{th}-degree polynomials. The linear parallel spring reduced 26.3% sit-to-stand RMS knee torque compared to the no-spring configuration. The 3^{rd}-degree polynomials reduced an additional 7% sit-to-stand RMS knee torque with respect to the linear parallel spring. There was a significant RMS knee torque reduction between the 1^{st} (linear) and 3^{rd}-degree polynomials. However, polynomials of the 4^{th}-degree or higher reduced an additional less than 0.6% RMS torque compared to 3^{rd}-degree polynomials. This additional reduction was not considered meaningful. Based on these results, a linear spring provides a substantial reduction in RMS knee torque, and higher-order polynomials offer diminishing returns beyond the 3^{rd} degree.

The optimization framework shown in FIG. 6 supports the modularity of the exoskeleton 100. Because the optimal stiffness and preload depend on the user's height and weight and the activity being performed, different users require different stiffness-preload combinations. The modular design of the exoskeleton 100 allows the stiffness to be adjusted by selecting elastic resistance elements 108 of appropriate stiffness (e.g., different TheraBand colors) and the preload to be adjusted by changing the routing length of the elastic resistance elements 108 through the first brace 102 or the second brace 104, as described above with reference to FIGS. 1 and 3.

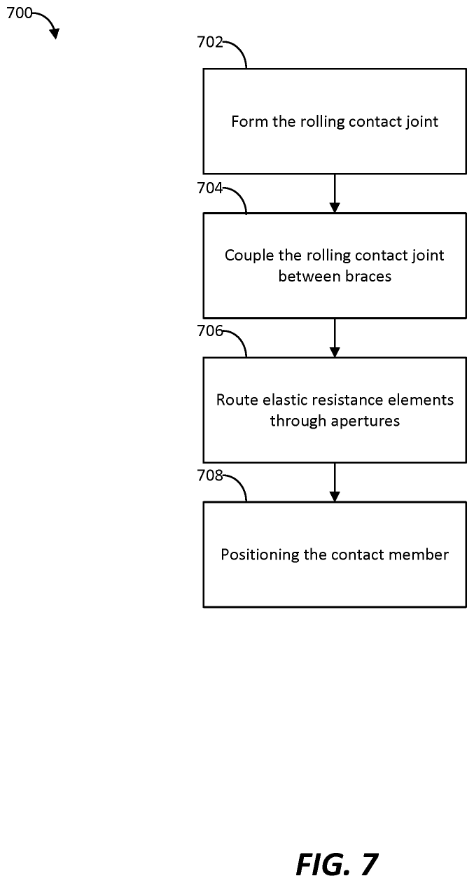

Referring now to FIG. 7, a flowchart illustrating a process 700 of making a passive knee exoskeleton 100 is shown, according to some embodiments.

At operation 702, at least one rolling contact joint 106 is formed. The rolling contact joint 106 comprises a first body 120 and a second body 122 having respective curved contact surfaces configured to roll against each other to provide rotation about multiple centers of rotation. The rolling contact joint 106 is configured to have multiple centers of rotation, like the human knee joint, by using the mechanism of Jacob's ladder. The first body 120 and the second body 122 are connected through a plurality of flexures (e.g., three stripes of polycarbonate film) as flexible components.

In some embodiments, the rolling contact joint 106 is formed as a monolithic structure by additive manufacturing (e.g., 3D printing), so that the first body 120, the second body 122, and the plurality of flexures are fabricated as a single part. 3D printing in one part saves time from part assembly. In other embodiments, the rolling contact joint 106 may be formed by injection molding, CNC machining, or other fabrication methods.

The curved contact surfaces of the first body 120 and the second body 122 may be configured based on the geometry of the lateral knee joint from anatomical literature, with the first body 120 having a radius corresponding to the femur geometry and the second body 122 having a radius corresponding to the tibia geometry.

At operation 704, the at least one rolling contact joint 106 is coupled between a first brace 102 and a second brace 104. The first brace 102 defines a first plurality of apertures 118, and the second brace 104 defines a second plurality of apertures 118. The first brace 102 is configured to be positioned along a first limb segment of a wearer (e.g., the thigh) and the second brace 104 is configured to be positioned along a second limb segment of the wearer (e.g., the shank). In some embodiments, two rolling contact joints 106 are coupled on opposing lateral and medial sides of the first brace 102 and the second brace 104.

At operation 706, each of a plurality of elastic resistance elements 108 is routed (e.g., sewn, threaded) through at least one aperture 118 of the first plurality of apertures and at least one aperture 118 of the second plurality of apertures. The plurality of elastic resistance elements 108 may be arranged in parallel with the at least one rolling contact joint 106. In some embodiments, the elastic resistance elements 108 include elastic resistance tubes (e.g., TheraBand resistance tubes). The elastic resistance elements 108 may be sewn through holes on the first brace 102 and the second brace 104 so that they allow for changing preload of the exoskeleton 100 if needed. In other embodiments, the elastic resistance elements 108 may be coupled to the first brace 102 and the second brace 104 by clips, hooks, friction-fit channels, or other fastening methods. In some embodiments, the elastic resistance elements 108 are of selectable stiffness, and each elastic resistance element 108 can be independently selected from elastic resistance elements of different stiffness values (e.g., different TheraBand colors) to produce a desired torque profile for the exoskeleton 100 based on the wearer's height and weight.

At operation 708, at least one contact member is positioned between the first brace 102 and the second brace 104. In some embodiments, an upper contact member 110 (e.g., an upper kneecap guard) is positioned on the first brace 102 and a lower contact member 112 (e.g., a lower kneecap guard) is positioned on the second brace 104. Each of the upper contact member 110 and the lower contact member 112 has a curved outer surface configured to contact at least a portion of the plurality of elastic resistance elements 108 during rotation of the at least one rolling contact joint 106. The contact members 110, 112 thereby define a routing path for the elastic resistance elements 108 that varies as a function of a rotation angle of the at least one rolling contact joint 106. In some embodiments, the upper contact member 110 and the lower contact member 112 are interchangeable with contact members of different sizes (e.g., 90 mm and 100 mm lengths) to adjust the torque profile of the exoskeleton 100.

In some embodiments, the method further comprises attaching the first brace 102 and the second brace 104 to an article of apparel 116 (e.g., pants). The first brace 102 and the second brace 104 are attached to the article of apparel 116 by sewing rigid structural elements 114 (e.g., carbon fiber rods) in the medial and lateral sides of the article of apparel 116, such that the first brace 102 and the second brace 104 distribute load from the plurality of elastic resistance elements 108 over a surface area of the first limb segment and the second limb segment of the wearer.

While the examples provided herein illustrate specific implementations and applications, it is understood that the disclosed subject matter encompasses a wide range of configurations, adaptations, and use cases within the scope of the claims.

While this disclosure has described certain embodiments, it is understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, the present disclosure is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A passive knee exoskeleton, comprising:
a first brace configured to be positioned along a first limb segment of a wearer;
a second brace configured to be positioned along a second limb segment of the wearer;
at least one rolling contact joint coupling the first brace to the second brace, the at least one rolling contact joint comprising a first body and a second body having respective curved contact surfaces that roll against each other to provide rotation about multiple centers of rotation; and
a plurality of elastic resistance elements coupled to the first brace and the second brace and arranged in parallel with the at least one rolling contact joint, the plurality of elastic resistance elements configured to store elastic potential energy during movement of the at least one rolling contact joint in a first rotational direction and to release the elastic potential energy during movement in a second rotational direction to modulate torque at a knee joint of the wearer.

2. The passive knee exoskeleton of claim 1, wherein the first body and the second body are connected by a plurality of flexures and formed as a monolithic structure.

3. The passive knee exoskeleton of claim 2, wherein the monolithic structure is formed by additive manufacturing.

4. The passive knee exoskeleton of claim 2, wherein the plurality of flexures comprise a polymer composite material.

5. The passive knee exoskeleton of claim 1, wherein the curved contact surfaces of the first body and the second body are circular, and wherein a radius of the curved contact surface of the first body differs from a radius of the curved contact surface of the second body.

6. The passive knee exoskeleton of claim 5, wherein the radius of the curved contact surface of the first body corresponds to a femur geometry of a lateral knee joint and the radius of the curved contact surface of the second body corresponds to a tibia geometry of the lateral knee joint.

7. The passive knee exoskeleton of claim 1, wherein the first brace defines a first plurality of apertures and the second brace defines a second plurality of apertures, and wherein each elastic resistance element of the plurality of elastic resistance elements is routed through at least one aperture of the first plurality of apertures and at least one aperture of the second plurality of apertures.

8. The passive knee exoskeleton of claim 7, further comprising at least one contact member positioned between the first brace and the second brace, the at least one contact member having a curved outer surface that contacts at least a portion of the plurality of elastic resistance elements during rotation of the at least one rolling contact joint, thereby defining a routing path for the elastic resistance elements that varies as a function of a rotation angle of the at least one rolling contact joint.

9. The passive knee exoskeleton of claim 8, wherein the at least one contact member comprises an upper contact member coupled to the first brace and a lower contact member coupled to the second brace.

10. The passive knee exoskeleton of claim 9, wherein each of the upper contact member and the lower contact member has a circular cross-section.

11. The passive knee exoskeleton of claim 9, wherein the upper contact member and the lower contact member are interchangeable with contact members of different sizes.

12. The passive knee exoskeleton of claim 8, wherein the routing path produces a nonlinear torque-angle profile from the plurality of elastic resistance elements across a range of rotation angles of the at least one rolling contact joint.

13. The passive knee exoskeleton of claim 1, wherein the plurality of elastic resistance elements comprise elastic resistance tubes.

14. The passive knee exoskeleton of claim 13, wherein the elastic resistance tubes are individually replaceable with elastic resistance tubes of different stiffness to adjust a torque profile of the passive knee exoskeleton.

15. The passive knee exoskeleton of claim 1, wherein a preload of the plurality of elastic resistance elements is adjustable by changing a routing length of the elastic resistance elements through the first brace or the second brace.

16. The passive knee exoskeleton of claim 1, further comprising an article of apparel to which the first brace and the second brace are attached, the article of apparel distributing load from the plurality of elastic resistance elements over a surface area of the first limb segment and the second limb segment of the wearer.

17. The passive knee exoskeleton of claim 16, wherein the first brace and the second brace are attached to the article of apparel by sewing.

18. The passive knee exoskeleton of claim 16, wherein the article of apparel comprises pants, and wherein the first brace and the second brace comprise rigid structural elements extending along medial and lateral sides of the pants.

19. The passive knee exoskeleton of claim 1, comprising two rolling contact joints positioned on opposing lateral and medial sides of the knee joint of the wearer.

20. A method of making a passive knee exoskeleton, comprising:
forming at least one rolling contact joint comprising a first body and a second body having respective curved contact surfaces configured to roll against each other to provide rotation about multiple centers of rotation;
coupling the at least one rolling contact joint between a first brace defining a first plurality of apertures and a second brace defining a second plurality of apertures, the first brace configured to be positioned along a first limb segment of a wearer and the second brace configured to be positioned along a second limb segment of the wearer;
routing each of a plurality of elastic resistance elements through at least one aperture of the first plurality of apertures and at least one aperture of the second plurality of apertures, the plurality of elastic resistance elements arranged in parallel with the at least one rolling contact joint; and
positioning at least one contact member between the first brace and the second brace, the at least one contact member having a curved outer surface configured to contact at least a portion of the plurality of elastic resistance elements during rotation of the at least one rolling contact joint, thereby defining a routing path for the plurality of elastic resistance elements that varies as a function of a rotation angle of the at least one rolling contact joint.
